(19) United States
(12) Patent Application Publication
(10) Pub. No.: US 2006/0221246 A1
(43) Pub. Date: Oct. 5, 2006

(54) Image display device and method thereof

(75) Inventor: Hee Tae Yoo, Daegu-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/392,706

(22) Filed: Mar. 30, 2006

(30) Foreign Application Priority Data
Mar. 31, 2005 (KR) 10-2005-0027261

(51) Int. Cl. H04N 3/27; H04N 9/74

(52) U.S. Cl. 348/581; 348/554

(57) ABSTRACT

Provided is a an image display device comprising: a tuner selecting a broadcasting signal; a demux separating a video signal, an audio signal and an additional signal from a broadcasting signal selected by the tuner; an up/down scaler with a resolution selected by the user; a display unit for displaying a video signal scaled in the up/down scaler; a key input unit receiving an user command; and a controller controlling the up/down scaler so that a resolution of a video signal displayed in accordance with user commands.

### BACKGROUND OF THE INVENTION

1. Field of the Invention

The present invention relates to an image display device and an image display method, more particularly, to an image display device displaying an image in compliance with a resolution selected by a user and an image display method.

2. Description of the Related Art

A current television technology, a standard definition television (SDTV) has been developed in the mid-twenties century based on a standard analog technology. The disadvantage of the SDTV broadcasting is that an amount of information that the user can watch is limited.

In order to overcome the disadvantage, a digital TV technology, a high definition television (HDTV) is designed to digitalize and compress a TV signal before the signal is being transmitted, therefore HDTV can transmit more data than SDTV.

One major advantage of HDTV over SDTV is that the HDTV can transmit more data than SDTV, so the HDTV can transmit a high-resolution image.

For example, and SD format used in the SDTV has a frame size of 720*480, 704*480 and 640*480, and a HD format used in the HDTV has a frame size of 1920*1080 and 1280*720.

FIG. 1 is a block diagram showing a conventional image display device, and FIG. 2 is a flow chart describing a method for displaying an image signal in a conventional image display device.

As shown in FIG. 1, a conventional image display device consists of a tuner 10 that selects a received broadcasting signal, a demux that separates an video signal, a voice signal and an additional information from the broadcasting signal selected in the tuner 10, a scaler 12 that finds a resolution of a video signal resolution in the demux 11 to scale it to be appropriate to the display unit 13, a key input portion 15 that inputs a user command, a controller 14 that controls the tuner 10, the demux 11, scaler 12 and the display unit 13 in compliance with the user commands in key input portion 15 and a memory 16 storing a broadcasting signal.

Meanwhile, the conventional display device is configured to display only broadcasting signals with a specific resolution in compliance with its capabilities, and the video signal of an SD format may be displayed, but the video signal of an HD format may not be displayed.

In addition, as shown in FIG. 1, an image display device may have a function for scaling an image signal to be appropriate to the resolution (SD format) of the display unit 13 and down-scaling an image signal of an HD format to display it with a resolution of an SD format.

FIG. 2 is a flow chart describing an image display method of a conventional image display device.

The conventional image display device scales an image signal with a resolution appropriate to a display unit when the image signal is received. (S210) (S220)

If a user commands to store an image signal, the image signal, which is scaled to a specific resolution, is stored in the memory, and the image signal is displayed by the display unit. (S230) (S240) (S250)

If there is no user command for storing an image signal, the image signal scaled to a specific resolution is displayed by the display unit. (S230) (S250)

The conventional image display described above does not suggest a method for storing or displaying an image signal with a resolution selected by a user.

In other words, a user can not display or store a broadcasting signal with a resolution desired by the user. Generally, the image signal resolution is determined to be displayed or stored in compliance with capabilities of an image display device. Thus, it is difficult to satisfy the requests of a user.

For example, in case of movies or soap operas, the resolution of an image signal is important in compliance with a type of broadcasting programs, and in case of news or sports, where a transmitting the contents is more important than a resolution of an image signal.

Accordingly, if a user can selects a resolution of image signal to be stored or displayed, it is possible to provide better satisfaction to the user.

### SUMMARY OF THE INVENTION

It is an object of the present invention to provide an image display device or a display method to scale image signal to be stored or displayed in compliance with the resolution selected by a user.

An image display device according to the present invention comprises: a tuner selecting a broadcasting signal; a demux separating a video signal, an audio signal and an additional signal from a broadcasting signal selected by the tuner; an up/down scaler scaling a video signal separated from the demux in compliance with a resolution selected by the user; display unit for displaying an image signal scaled in the up/down scaler; a key input unit receiving a user command; and a controller controlling the up/down scaler so that a resolution of an video signal displayed in compliance with the user command request.

In addition, an image display method according to the present invention comprises: inputting a video signal; determining a resolution of the video signal; scaling the video signal with a resolution selected by the user; and displaying the scaled video signal.

Moreover, an image display method according to the present invention comprises: selecting and receiving a broadcasting signal; separating an video signal from the broadcasting signal; determining a resolution of the video signal; scaling and storing the image signal with the first resolution selected by the user; and scaling and displaying the stored image signal with the second resolution selected by the user.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram describing a conventional image display device;

FIG. 2 is a flow chart describing a method for displaying an video signal in a conventional image display device;

FIG. 3 is a block diagram describing a configuration of an image display device in accordance with the present invention;

FIG. 4 is a block diagram describing embodiment of an up/down scaler in an image display device in compliance with the present invention; and

FIG. 5 is a flow chart describing an image display method in accordance with the present invention.

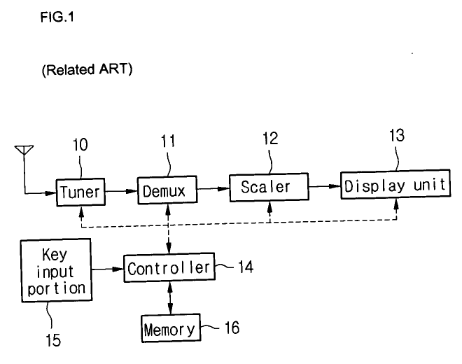

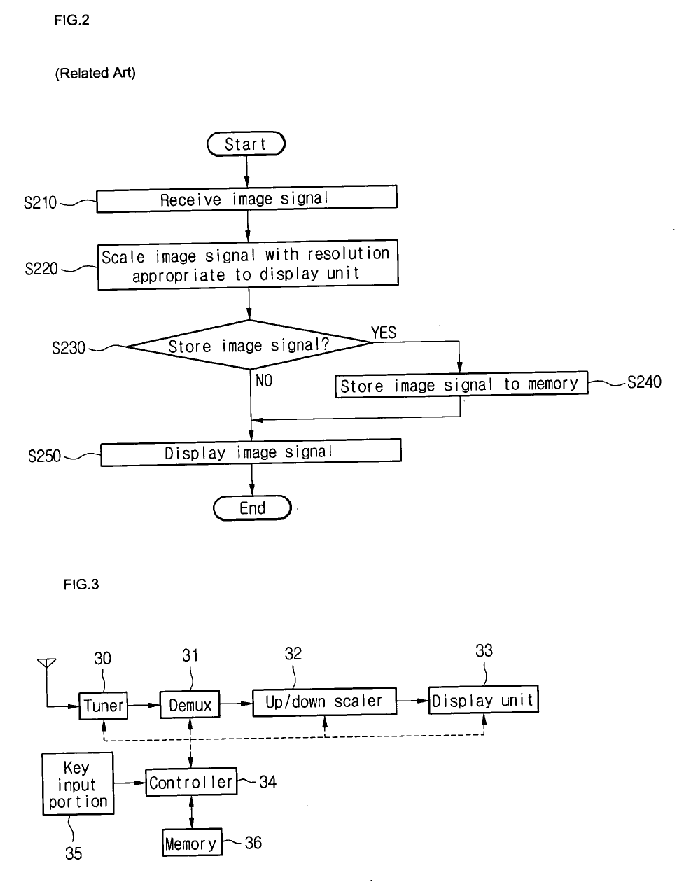

### DETAILED DESCRIPTION OF THE INVENTION

Reference will now be made in detail to the preferred embodiments of the present invention, examples of which are illustrated in the accompanying drawings.

FIG. 3 is a block diagram describing a configuration of an image display device in accordance with the present invention.

Referring to FIG. 3, an image display device in accordance with the present invention includes a tuner 30, a demux 31, an up/down scaler 32, a display unit 33, a key input portion 35, a controller 34 and a memory 36.

The tuner 30 selects a broadcasting signal selected by a user, and the demux 31 splits a broadcasting signal selected in the tuner 30 into a video signal, an audio signal and an additional signal.

The key input portion 35 receives a user command, and the user command may be a channel tuning command, a resolution setting command of a user, a storing command of a broadcasting signal and a broadcasting display command.

The memory 36 may let the user to set a resolution or store a broadcasting signal.

The up/down scaler 32 up-scales or downscales a resolution of a video signal separated from the demux 31. In other words, a resolution of the video signal is changed in compliance with a control of the controller 34 with reference to the resolution set by the user.

The display unit 33 displays a video signal scaled in the up/down scaler 32 or displays a video signal scaled in the up/down scaler 32, which is stored in the memory 36.

An image display device in accordance with the present invention configured as above receives a broadcasting signal of a channel selected by the user through the tuner 30 if a power-on command is input by the key input portion 35, and the demux 31 divides the received broadcasting signal into a video signal, an audio signal the additional information.

The controller 34 can extract the information related to a resolution of a video signal from the broadcasting signal. The information related to a resolution of the video signal may be obtained through the additional information.

A user may execute an on Screen Display (OSD) menu through the key input portion 35 to select a resolution of a video signal by the OSD menu and can be set to display with different resolutions by channels or types of a broadcasting program.

Note that the channel information and the information type of a broadcasting program can be obtained by the additional information.

In the meantime, if a resolution of the received video signal is in a SD format, it is changed to a HD format to be stored in the memory 36.

In addition, if a resolution of the received video signal is a HD format, it is changed to a SD format to be stored in the memory 36. In this case, a video signal stored in the memory 36 has a compressed effect result.

Similarly, a video signal stored in the memory 36 may be displayed in accordance with a user-defined resolution.

For example, the video in a HD (High Definition) format is down-scaled to a SD (Standard Definition) format to be stored in the memory 36, and a video signal in a SD format, which is stored in the memory 36 is up-scaled to a HD format to be displayed.

The change of a resolution in a video signal described above is set by the user.

Note that the down-scaling is not limited to scaling a video signal of HD format to an image signal of SD format. For example, among video signals in a HD format, a 1920*1080 frame may scale to a 1280*720 frame.

Similarly, the up-scaling is not limited to scaling a video signal of SD format to a video signal in a HD format. For example, among a video signal in a HD format, a 1280*720 frame may scale to a 1920*1080 frame.

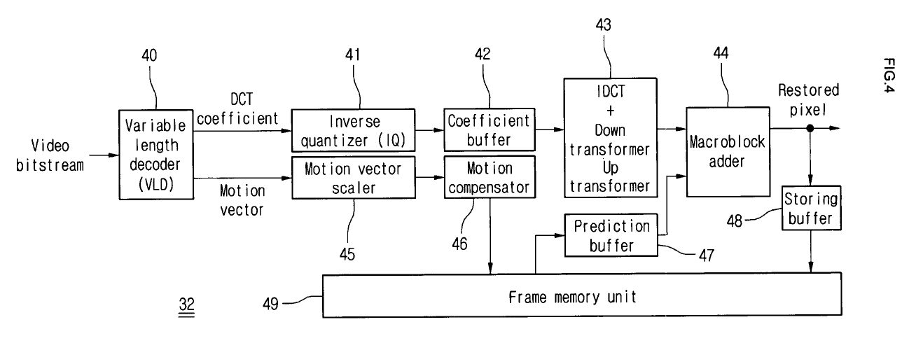

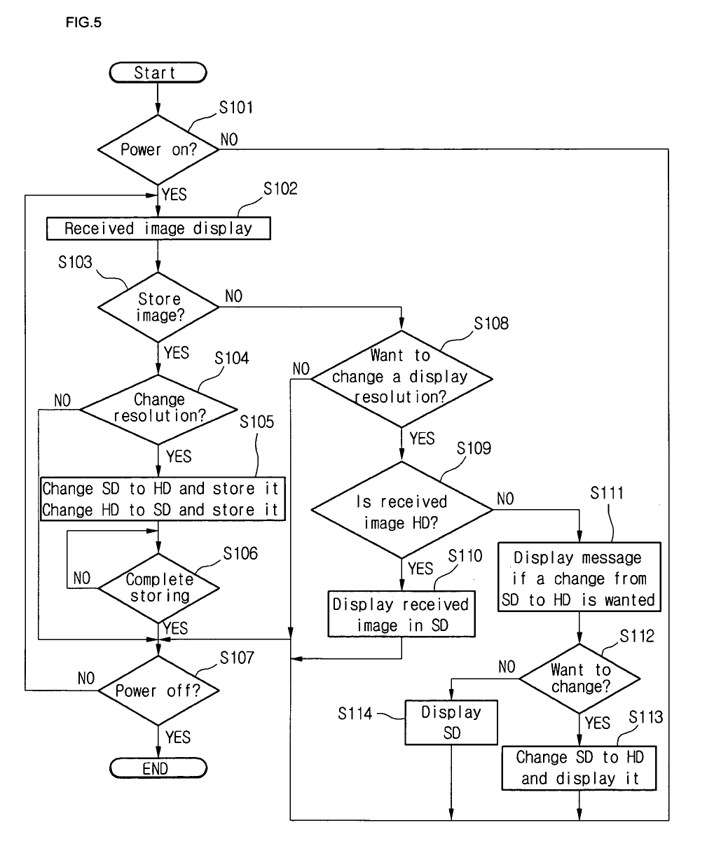

FIG. 4 is a block diagram describing an embodiment of up/down scaler in an image display device in accordance with the present invention.

Referring to FIG. 4, the up/down scaler 32 includes: a variable length decoder VLD 40 analyzing an input compressed bit-stream, an inverse quantizer IQ 41 quantizing inversely the compressed bit-stream, which is analyzed by the VLD 40 and transforming a DCT coefficient, an inverse discrete cosine transformer IDCT 43 inversely cosine transforming after temporarily storing a bit-stream in a coefficient buffer 42, which is output in a macroblock type by the inverse quantizer 41, a motion compensation MC 46 producing a motion compensated pixel value using a motion vector scaled from the motion vector scaler 45, a macroblock adder 44 adding a data output from the inverse discrete cosine transformer 43 and a data extracted by a control signal of the macroblock and finally a frame memory unit 49 storing a picture data output in the macroblock adder 44 and extracting the corresponding data by the macroblock control signal.

Here, a motion compensated pixel value extracted in the frame memory unit 49 is temporarily stored in accordance with a control signal of a macroblock to input to the macroblock adder 44 with the data output from the inverse discrete cosine transformer 43, and the data output from the macroblock adder 44 is temporarily stored in the storing buffer 48 and then stored in the frame memory unit 49.

The inverse discrete cosine transformer 43 includes a down transformer and an up transformer.

The down transformer and the up transformer directly transform a resolution of a video image signal in a frequency domain.

Specifically, the inverse quantizer transforms a DCT coefficient in order to up-scale or down-scale a resolution of a video signal, and a DCT coefficient inversely cosine transforms to obtain a difference pixel value. A motion vector output from the variable length decoder 40 is scaled in the motion vector pertinent to the block region transformed in the inverse quantizer 41, and a motion compensated value is obtained in the motion compensator unit 46.

Moreover, the macro adder 44 adds a difference pixel value in a macroblock unit obtained from the inverse cosine transformer 43 and a motion compensating value of the pixel obtained in the motion compensator 46 to calculate a final pixel value and then store it in the frame memory 49.

As described above, the up/down scaler 32 shown in FIG. 4 up/down scales a video signal separated in the demux 31 by controls of a control unit 34 in FIG. 3

In the meantime, an information of a resolution set by a user may be stored in the memory 36, the controller 34 controls the up/down scaler 32 with reference to a resolution information stored in the memory 36.

FIG. 5 is a flow chart describing an image display method in accordance with the present invention.

Referring to FIG. 5, first, if a user inputs a power-on command, the video signal received will be displayed. (S101) (S12)

It is determined whether the received video signal should be stored or not. Note that determining whether to store the video signal is decided by a predetermined recording set by a user in advance or is determined by a user decision in a real time.

Next, if a user wants to store the video signal, the user is asked whether to change a resolution of the video signal to store the video signal. (S104)

If a user wants to store a changed resolution of the video signal in a SD format, this signal should be converted to a HD format, and then store the resolution. If the received video signal is in a HD format, the signal should be converted to a SD format, and then store the resolution. (S105) However, a resolution is converted only from the HD format to the SD format, and vice versa, it can be customized in compliance with an user preference. For example, regardless of whether the video signal is in a HD format or in a SD format, a user can store in a 720*480 frame.

Next, it is determined if storing is done.

If storing is done, and a user inputs a power-off command, then the process terminates and if not, then the process returns to the step S102. (S107)

In the meantime, when displaying the received video signal, a resolution of a video signal is changed to determine whether to display or not.

If an user wants to change a video display quality, it is determined whether the received video is in a HD format. (S109)

According to the determination results, (S109) if the video signal is in a HD format, the signal is converted to a SD format to be displayed.

Meanwhile, if the video signal is in a SD format, the video signal is converted to a HD format to be displayed. (S111) Accordingly, if a user wants to change a format, a video signal in a SD format is converted to a HD format to be displayed. (S112) (S113)

In addition, if a user does not want to change a video signal, then the signal is in a SD format.

Note that a change of a resolution of the video signal is limited to one embodiment; it is possible to change the resolution of a video image in accordance with a user's preference.

For example, in case that the video signal stored in a memory as well as the received video signals are displayed, it is possible to change a resolution of the video signal. In other words, the user can store or display a video signal in accordance with a selected resolution, and can store a video signal in accordance with a selected resolution and display the stored image signal in accordance with the stored image signal.

An image display device and a method for displaying a video according to the present invention can store or display a video signal in accordance with a resolution selected by a user preference, and the present invention has an advantage to display the stored video signal in accordance with a selected resolution.

What is claimed is:

1. An image display device comprising:
a tuner selecting a broadcasting signal;
a demux separating a broadcasting signal selected by the tuner into an video signal, an audio signal and an additional signal;
an up/down scaler scaling a video signal separated from the demux in accordance with a resolution selected by the user;
a display unit for displaying a video signal scaled in the up/down scaler;
a key input unit receiving an user command; and
a controller controlling the up/down scaler so that a resolution of a video signal displayed in accordance with the user's request command.

2. The image display device of claim 1, further comprising;
a memory storing a resolution set by a user preference.

3. The image display device of claim 2, wherein the memory stores a video signal scaled in accordance with a resolution selected in accordance with the user.

4. The image display device of claim 1, wherein the resolution is determined by a user's channel preference.

5. The image display device of claim 1, wherein the resolution is determined by a user's program preference

6. The image display device of claim 1, wherein the resolution is determined in accordance with information extracted from additional information separated from the broadcasting signal.

7. The image display device of claim 1, wherein the up/down scaler comprises:
a variable length decoder VLD 40 analyzing an input compressed bit-stream;
an inverse quantizer quantizing inversely the compressed bit-stream, which is analyzed by the variable length decoder and transforming a DCT coefficient;
an inverse discrete cosine transformer inversely cosine transforming after temporarily storing a bit-stream in a coefficient buffer, which is output in a macroblock type by the inverse quantizer;
a motion compensation producing a motion compensated pixel value using a motion vector scaled from the motion vector scaler
a macroblock adder adding a data output from the inverse discrete cosine transformer and a data extracted by a control signal of the macroblock;
a frame memory unit storing a picture data output in the macroblock adder and extracting the corresponding data by the macroblock control signal.
a macro block adder adding data output from the inverse discrete cosine transformer and data extracted by a control signal of the macroblock; and
a frame memory unit storing a picture data output from the macroblock adder to extract a corresponding data by the macroblock control signal.

8. An image display method comprising:
inputting an image signal;
determining a resolution of the video signal;
scaling the video signal with a resolution selected by the user; and displaying the scaled image signal.

9. The image display method of claim 8, wherein the input video signal is stored in a memory in accordance with a resolution selected by the user.

10. The image display method of claim 8, wherein the resolution of the video signal is extracted in the additional information received with the video signal.

11. The image display method of claim 8, wherein the resolution selected by the user is determined by a type of a video signal.

12. The image display method of claim 8, wherein the resolution selected by the user is determined in accordance with a channel receiving an image signal.

13. The image display method of claim 8, wherein an image signal scaling is performed by an up-scaling or a down-scaling in accordance with a resolution by the user.

14. An image display method comprising:
selecting and receiving a broadcasting signal;
separating an image signal from the broadcasting signal;
determining a resolution of the video signal;
scaling and storing the video signal with the first resolution selected by the user; and scaling and displaying the stored image signal with the second resolution selected by the user.

15. The method of claim 14, wherein the first resolution is a SDTV format, and the second resolution is a HDTV format.

16. The method of claim 14, wherein the resolution of the video signal is extracted from additional information received with the video signal.

17. The method of claim 14, wherein the first resolution or the second resolution selected by a genre of a video signal.

18. The method of claim 14, wherein the first resolution or the second resolution selected by the user is determined by a received channel.
